(19) United States
(12) Patent Application Publication
(10) Pub. No.: US 2026/0285705 A1
(43) Pub. Date: Sep. 24, 2026

(54) WATER INTAKE FILTRATION SYSTEM

(71) Applicant: OceanWell Co., Menlo Park, CA (US)

(72) Inventors: Michael M. Porter, Menlo Park, CA (US); Michael Gerdes, Menlo Park, CA (US); Mark Golay, Menlo Park, CA (US)

(21) Appl. No.: 19/677,777

(22) Filed: May 14, 2026

Related U.S. Application Data
(63) Continuation of application No. PCT/US2024/056243, filed on Nov. 15, 2024.
(60) Provisional application No. 63/599,515, filed on Nov. 15, 2023.

(51) Int. Cl. C02F 1/00; C02F 103/08

(52) U.S. Cl. CPC C02F 1/001; C02F 2103/08; C02F 2201/002; C02F 2303/16; C02F 2303/24

(57) ABSTRACT

A filtration system produces filtered water and returns captured solids to source water. The filtration system includes an intake filter subsystem fluidically coupled to the source water and to at least one pump, the intake filter subsystem configured to receive a flow of source water, capture organisms from the flow of source water, and produce a filtered intake flow of water. The filtration system is configured to operate in a plurality of operating modes, wherein, in a first operating mode, the filtered intake flow is received from the intake filter subsystem along a first fluid pathway to produce filtered water at a first system outlet, and, in a second operating mode, a flow of filtered water is provided to a second fluid pathway and a second system outlet to wash captured organisms back into the source water and maintain the source water environment.

### CROSS REFERENCE TO RELATED APPLICATION

This application is a continuation of International Application No. PCT/US2024/056243 filed Nov. 15, 2024 and entitled WATER INTAKE FILTRATION SYSTEM, which claims priority to U.S. Provisional Application Ser. No. 63/599,515 filed Nov. 15, 2023 entitled WATER INTAKE FILTRATION SYSTEM WITH SELF-CLEANING APPARATUS, the disclosures of which are incorporated herein by reference.

### TECHNICAL FIELD

This invention relates to a system and method for filtering out solids from a flow of source water.

### BACKGROUND

In the United States, there are ample amounts of freshwater (reservoirs, lakes, and rivers) and virtually unlimited supplies of seawater (oceans) that can be used to supply water for drinking, agriculture, cooling, energy production, manufacturing, and other water-intensive processes well into the future. However, as coastal facilities intake water, habitats continue to be put at risk. This high environmental cost is largely because most intake methods rely on legacy technologies that result in the mortality of all entrained lifeforms, including plankton, eggs, larvae, and juvenile organisms. Although newer technologies, such as self-cleaning screens and subsurface wells, may offer improvements, little remains known about their impacts on planktonic and benthic life. Even the California Ocean Plan Amendment (OPA), often considered the gold standard for ocean protections, assumes 100% mortality of entrained organisms in its regulatory guidelines for open water intake screens and recommends subsurface wells, a more costly, size limited, and site restricted method, as the preferred technology.

Water intake systems, essential for various applications such as desalination and power generation, have traditionally been sourced either directly from surface bodies like oceans, lakes, and rivers (open water intakes) or underground wells (subsurface intakes). While open water methods are more common, they pose significant environmental risks, particularly to marine life, which can be trapped or inadvertently killed by the intake process. Subsurface methods are less harmful to marine organisms. Still, they can disrupt benthic ecosystems and groundwater supplies, are energy-intensive, and are limited by geographical and environmental factors, making them less adaptable and more expensive in the long run. Moreover, submerged feedwater intake systems that draw in fresh, brackish, or saline water, such as wedge wire screens, generally require routine maintenance for removing impinged lifeforms, detritus, or other particulate matter that may occlude the intake surface; and the removal of biologic, organic or inorganic foulants that may occlude any or all of the intake surface or support structures.

To counteract these challenges, a range of techniques have been developed to reduce the environmental impact of open water intake systems. These include advanced screen designs that aim to minimize the capture of marine life and automated cleaning systems that help maintain the efficiency and longevity of the screens. Despite improvements, all cleaning methods have limitations, with some potentially harming marine life or requiring significant energy and maintenance. Moreover, current intake systems inevitably result in some degree of mortality for small organisms that pass through, leading to further environmental concerns. Post-intake water typically undergoes a series of pretreatment processes to ensure it is clean and safe for its intended use. These processes often involve chemicals and physical filters, which, while possibly effective, can have their own environmental and spatial footprints.

### SUMMARY

In certain embodiments, a filtration system is disclosed for producing filtered water and returning captured solids to source water. The filtration system includes at least one pump; an intake filter subsystem fluidically coupled to the source water and the at least one pump, the intake filter subsystem configured to receive a flow of source water, capture organisms from the flow of source water, and produce a filtered intake flow of water. The filtration system is configured to operate in a plurality of operating modes, wherein, in a first operating mode, the filtered intake flow is received from the intake filter subsystem along a first fluid pathway to produce filtered water at a first system outlet, and, in a second operating mode, a flow of filtered water is provided to a second fluid pathway and a second system outlet to wash captured organisms back into the source water.

In additional embodiments, a multi-stage filtration system for producing filtered water and returning captured solids to source water is provided. The multi-stage filtration system includes at least one pump; an intake filter subsystem, fluidically coupled to the at least one pump and configured to receive a flow of source water and filter out organisms from the flow of source water, and a self-cleaning subsystem coupled to the intake filter subsystem and configured to periodically remove and displace organisms from the intake filter subsystem into an interstitial space between successive filters of the intake filter subsystem. The multi-stage filtration system is configured to operate in a plurality of operating modes wherein, in a first operating mode, the intake filter subsystem receives the flow of source water to produce a flow of filtered water along a first fluid pathway, and, in a second operating mode, the flow of filtered water is provided to the interstitial space and flows along a second fluid pathway across downstream and upstream filter faces of the successive filters and through an outlet an outlet of the multi-stage filtration system to return the organisms to source water.

A method of producing filtered water and returning captured solids to source water is also disclosed. The method includes operating a multi-stage filtration system in a first operating mode to receive a flow of source water along a first fluid pathway and produce a flow of filtered water at a first system outlet, the first fluid pathway comprising a plurality of successively finer filters configured to remove organisms from the flow of source water. The method also includes operating the system in a second operating mode to direct the flow of filtered water along a second fluid pathway to a second system outlet to return the organisms to source water, the second fluid pathway comprising an interstitial space between successive filters and flowing across downstream and upstream filter faces of the interstitial space to the second system outlet.

### BRIEF DESCRIPTION OF THE DRAWING

FIG. 1 is a filter system for producing filtered water and maintaining a source water environment in accordance with one example of the present invention.

FIGS. 2A-2B illustrate an intake-event, or a first mode of operation, of a filter system in accordance with examples of the present invention.

FIGS. 2C-2G illustratively show filtration systems with self-cleaning subsystems in accordance with examples of the present invention.

FIGS. 2H-2J illustratively show a side-view of a backflush or backwash mode of operation in accordance with examples of the present invention.

FIGS. 3A-3B illustratively show a filtration system in accordance with examples of the present invention.

FIGS. 4A-4B illustratively show a filtration system in accordance with examples of the present invention.

FIGS. 5A-5B illustratively show a filtration system in accordance with examples of the present invention.

FIGS. 6A-6C illustratively show a filtration system with a plurality of concentric cylindrical filters in accordance with examples of the present invention.

FIG. 7 illustratively shows process diagrams of the disclosed multistage filtration system versus a traditional submerged intake system in accordance with an example of the present invention.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, an apparatus that contains “a” reverse osmosis membrane includes “one or more” such membranes.

The term “backflush” when used with respect to a mode or event refers to a flow of filtered water through a flow path that discharges suspended solids and organisms from one or more interstitial spaces in the flow path into a collection system or into source water.

The term “backwash” refers to a combination or sequence of cleaning or backflush modes for dislodging and washing solids and organisms from one or more filters into a collection system or into source water.

The term “brine” refers to an aqueous solution containing a materially greater sodium chloride concentration than that found in typical saltwater, viz., salinity corresponding to greater than about 3.5% sodium chloride. It should be noted that different jurisdictions may apply differing definitions for the term “brine” or may set different limitations on saline discharges. For example, under current California regulations, discharges should not exceed a daily maximum of 2.0 parts per thousand (ppt) above natural background salinity measured no further than 100 meters horizontally from the discharge point. In other jurisdictions, salinity limits may for example be set at levels such as 1 ppt above ambient, 5% above ambient, or 40 ppt absolute.

The term “cleaning” when used with respect to a mode or event refers to a physical process for dislodging impinged matter from one or more filters using brushes, water jets, air bursts, backpressure or other such techniques.

The term “concentrate” refers to a desalination apparatus discharge stream having an elevated salinity level compared to ambient surrounding seawater, but not necessarily containing sufficient salinity to qualify as brine in the applicable jurisdiction where such stream is produced.

The term “conduit” refers to a pipe or other hollow structure (e.g., a bore, channel, duct, hose, line, opening, passage, riser, tube or wellbore) through which a liquid flows during operation of an apparatus employing such conduit. A conduit may be but need not be circular in cross-section, and may for example have other cross-sectional shapes including oval or other round or rounded shapes, triangular, square, rectangular or other regular or irregular shapes. A conduit also may be but need not be linear or uniform along its length, and may for example have other shapes including tapered, coiled or branched (e.g., branches radiating outwardly from a central hub).

The term “depth” when used with respect to a submerged apparatus or a component thereof refers to the vertical distance, viz., to the height of a water column, from the free surface of a body of water in which the apparatus or component is submerged to the point of seawater introduction into the apparatus or to the location of the component.

The terms “desalinated water”, “fresh water” and “product water” refer to water containing less than 1000 parts per million (ppm), and more preferably less than 500 ppm, dissolved inorganic salts by weight. Exemplary such salts include sodium chloride, magnesium sulfate, potassium nitrate, and sodium bicarbonate.

The term “flow across” when used with respect to a filter having an upstream and downstream face and passages between the upstream and downstream faces through which filtrate can flow and in which retentate can be trapped, means a flow along a filter face rather than through the filter passages.

The term “fluid pathway” refers to the conduit(s), filter(s), interstitial space(s) and pump(s) through which a fluid may move in a chosen direction. The terms “first fluid pathway” and “second fluid pathway” refer to fluid pathways that are distinct (but which may include some path elements in common), and whose distinctness is not merely having identical path elements with different fluid flow directions along those elements.

The term “interstitial space” refers to a fluid flow path across a filter face between a downstream side of an upstream filter and an upstream side of a downstream filter.

The terms “living matter” and “organisms” are, for the purposes of the present disclosure, interchangeable, and mean organic matter that contains nucleic acids and can evolve. Organisms may be microorganisms, unicellular or multicellular, and include neuston, plankton, nekton, and benthos organisms that may be captured, entrapped, entrained, or impinged upon by subsea filtration of source water.

The term “microorganisms” means organisms that can be seen only though a microscope.

The term “microparticles” when used with respect to suspended pollutants refers to particles from 1 micrometer to 5 mm in size.

The term “multi-stage” when used with respect to a filtration system means that the system includes two or more filters arranged in series and having progressively smaller filtrate passages.

The term “offshore” refers to an apparatus, system or method that is situated or performed at sea, and at some distance from the shore.

The term “onshore” refers to an apparatus, system or method that is situated or performed on land.

The term “platform” refers to a supporting surface, typically level and flat, and typically raised with respects to its surroundings, on which equipment may be mounted. Offshore platforms may in some embodiments be non-level, non-flat, or partially or wholly submerged.

The term “seawater” refers to water containing more than 0.5 ppt dissolved inorganic salts by weight, and thus encompassing both brackish water (water containing 0.5 to 3.0 ppt dissolved organic salts by weight) as well as ocean water or other water containing more than 3.0 ppt dissolved organic salts by weight. In oceans, dissolved inorganic salts typically are measured based on Total Dissolved Solids (TDS), and typically average about 35 ppt TDS, though local conditions may result in higher or lower levels of salinity.

The term “solids” means water-insoluble matter, including living matter, particulates, suspended matter, foulants, detritus, or debris that may be captured, entrapped, entrained, or impinged upon by subsea filtration of source water.

The term “submerged” means underwater.

The term “submersible” means suitable for use and primarily used while submerged.

The term “topside” means above the surface of a body of water, e.g., above sea level for body of ocean water.

In one example, a self-cleaning and life-friendly filtration system and method are disclosed. A filtration system may include a pump, a self-cleaning subsystem, an intake filter subsystem, and multiple fluid pathways for producing filtered water and returning captured solids to a surrounding body of water.

However, while returning captured solids may be one feature of the disclosed filtration system, it is to be understood that the disclosed system may be beneficial in a variety of other ways as well. For example, even in environments without a substantial presence of solids, such filtration systems may allow for an efficient and effective means of producing filtered water allowing for in situ maintenance and longer runtimes. If organisms are present, the present system may, however, produce filtered water without appreciably killing captured organisms, impinging larger organisms, entraining smaller ones, and damaging the surrounding environment and benthic communities. In turn, this may lead to far better environmental outcomes both at the intake site and at an eventual discharge site. Additionally, such filtration systems may reduce the cost, energy requirements, and environmental impacts of natural water intakes, including those that supply desalination and water purification facilities, which, in turn, increases water supply flexibility and adaptability under the risks of long-term climate change and shorter-term drought. This may further allow for access and delivery of cleaner water from unusable waters without necessitating substantial pretreatment, chemicals, and land.

The filtration system and method provided herein may operate in any number of water sources with or without a presence of solids. Such sources may include ocean water, seas, gulfs, bays, estuaries, reservoirs, lake water, river water, or pond water. Specifically, such sources may include the 338 reservoirs operated by the US Bureau of Reclamation (>140 million ac-ft), Great Lakes (>18 billion ac-ft), Colorado and Mississippi Rivers (>1 billion combined ac-ft/yr), ocean waters in the Gulf of Mexico, Atlantic and Pacific Oceans (with virtually unlimited capacity), and many natural waters of US territories and military bases around the world with suitable offshore/coastal zones that could accept the filtration system. Additionally, it is to be understood that the present system may operate in any body of water. For example, this may include onshore or offshore waters of Australia, the United States, the Mediterranean Sea, the Indian Ocean, etc. Further, in one example, the system may be employed subsea at a depth of at least about 200 meters below surface level. For example, a depth of 200-1000 meters may be desirable in an aphotic zone, which is generally darker, colder, and clearer with lower particle counts/turbidity and lower biological activity than source waters from the photic zone near the sea surface. However, it is to be understood that these are mere examples only, and the filtration system may produce filtered water at nearly any depth in nearly any body of water, from fresh to brackish to saline.

In addition to supplying coastal facilities and submerged processing plants, the filtration system and method may also supply filtered water to offshore facilities, such as subsea desalination, ocean thermal energy conversion, ocean carbon capture, offshore hydrogen, seawater mining, pollution cleanup, ecosystem restoration, and other current and future innovations within the growing ocean economy. Additionally, such filtered water may be provided to irrigation operations and water-intensive industrial processes, e.g., a mining operation, oil and gas operation, semiconductor manufacturing operation, irrigation operation, or a textile manufacturing operation. Further applications for filtered water may include supplying a cooling system for a power plant, data center, or civil infrastructure. However, it is to be understood that these are mere examples, and other applications and processes may utilize the disclosed filtration system as well.

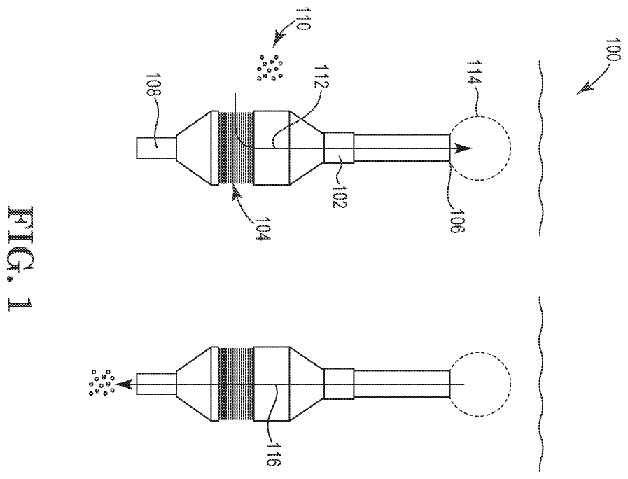

FIG. 1 is a filter system for producing filtered water and maintaining a source water environment in accordance with one example of the present invention. As shown, filter system 100 includes a reversible pump 102, a self-cleaning intake filter subsystem 104, an inlet/outlet 106 coupled to reversible pump 102, and a life-friendly return outlet 108. In operation, filter system 100 may operate in different operating modes to produce filtered water (an intake mode) and maintain a source water environment (backwash and backflush modes). In one example, a first, intake, operating mode of reversible pump 102 may draw a flow of source water with solids 110 through self-cleaning intake filter subsystem 104 along a first fluid pathway 112 to produce filtered or supply water 114 through outlet 106. In a second, backwash or backflush, operating mode, reversible pump 102 may operate in reverse to drive filtered or supply water 114 along a second fluid pathway 116 through life-friendly return outlet 108 to return any captured solids to source water. By returning captured solids, a source water environment may be maintained. In a further embodiment, non-living solids (e.g., microplastics and other microparticles) and may be separated from organisms in the collected solids using devices and techniques described in detail in copending International Application No. (Attorney Docket No. 40031-157), filed even date herewith and entitled Pollution Cleanup Using a Submerged Filtration Apparatus, the disclosure of which is incorporated herein by reference.

In some embodiments, filter system 100 preserves a thermo-physiochemical environment of resident organisms that may interact with system 100. System 100 may refrain from using chemicals and operate near ambient pressure, salinity, temperature, and dissolved gas concentrations. Additionally, as shown, reversible pump 102 may be located downstream of all filtration stages so that entrained organisms (up to a selected exclusion size) do not pass through the pump impellers.

One or more pumps, e.g., pump 102, may be upstream or downstream of the first and second filtration stages or any other downstream processes, e.g., a reverse osmosis process. In operation, pump 102 may create a differential pressure through filter system 100 to draw in unfiltered source water in a first operating mode and drive a flow of source water into and generally normal to the surfaces of each filtration stage. A pump impeller, shroud, and vane geometries may be designed to tune pump performance and efficiency as needed to optimize flow and avoid undesirable effects, such as turbulence, cavitation, backflow, swirling, eddies, or other disturbances. A selected pump type, e.g., axial vs. mixed vs. centrifugal, and efficiency, e.g., specific energy, may be highly dependent on scale, according to the desired volumetric capacity, pressure, and specific speed for a selected application.

As pump 102 draws in unfiltered source water along first fluid pathway 112, solids may be filtered out using any number of fluidically coupled stages along pathway 112. For example, system 100 may include three filtration stages in which a first stage has a larger opening size than a second and third stage. The second stage, in turn, may have a larger opening size than the third stage but a smaller opening size than the first stage. In this example, as fluid travels along path 112, smaller and smaller particulates and organisms may be captured along pathway 112 prior to a downstream process, e.g., a subsea reverse osmosis process.

Further, in one example, reversible pump 102 may pull source water through a multi-stage filtration system (in a first, forward mode of operation) and push filtered water through a backwash or backflush system (in a second, reverse mode of operation). In this example, during the first mode of operation, low approach velocities (below U.S. Environmental Protection Agency or “EPA” recommendations, of less than 0.5 feet per second) may be maintained by oversizing the outermost screen of intake filter subsystem 104 to eliminate the impingement of larger organisms to the surface of a filter, e.g., fine wedge wire slots, below EPA recommendations of less than or equal to 1 mm. This is possible because system 100 may operate submerged in a waterbody, relaxing size constraints related to land use and preventing pump cavitation. Further, mid-water submergence, sufficiently below the surface, and above the underwater floor, may reduce impacts to benthic communities and protect from atmospheric climate risks, such as droughts, floods, sea level rise, and extreme weather. Relative to bioactivity in the water column, a mid-water operation of system 100 may also minimize fouling and ingress water quality issues associated with surface and bottom events, such as algal blooms, turbidity currents, and suspended/dissolved pollutants which generally sink or rise when released into a natural waterbody.

While a first and a second flow path are discussed below, it is to be understood that such flow pathways may be discretely defined regions that source water, interstitial water, and filtered water may pass through. Such paths may be chosen based on an operating parameter of system 100. For example, a first operating mode may elicit a forward fluid pathway through system 100 while a second mode reverses the flow to cause a backwashing or backflushing event to return captured solids. Each flow path may be arranged in the form of interconnected pipe networks or other volumetric spaces that are in fluid communication with one another, but separated by filters, valves, or pumps, such that solids may be evacuated, backwashed or flushed out of the system during a backwash or backflush event. The flow pathways may have one or more inlet or outlet regions where fluid may enter or exit the interstitial spaces during a backwashing or backflushing event.

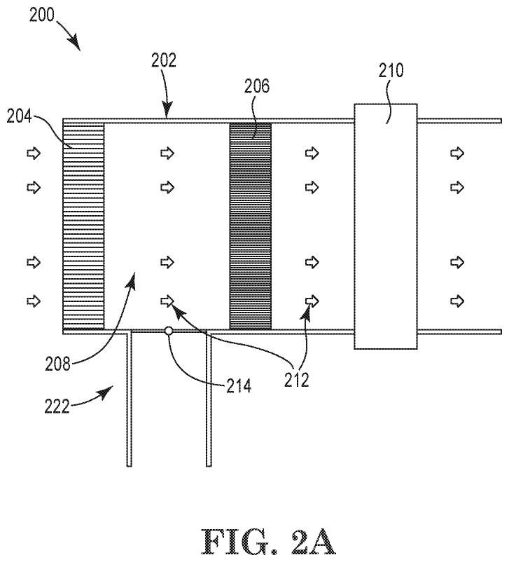

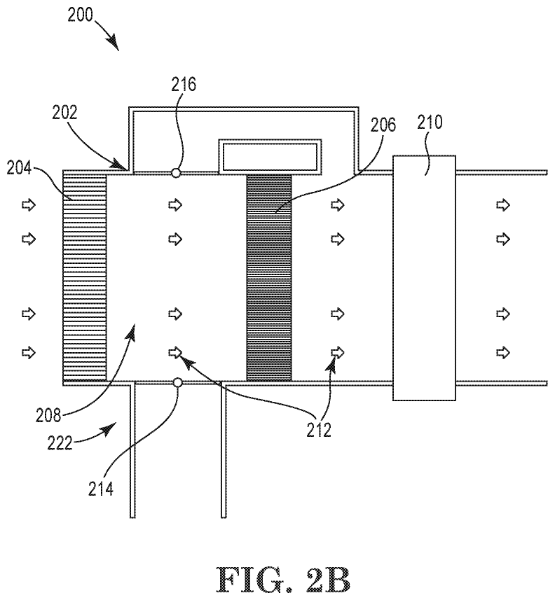

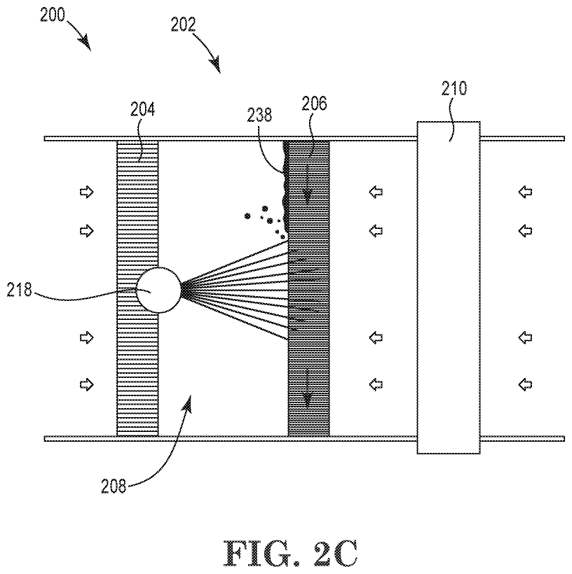

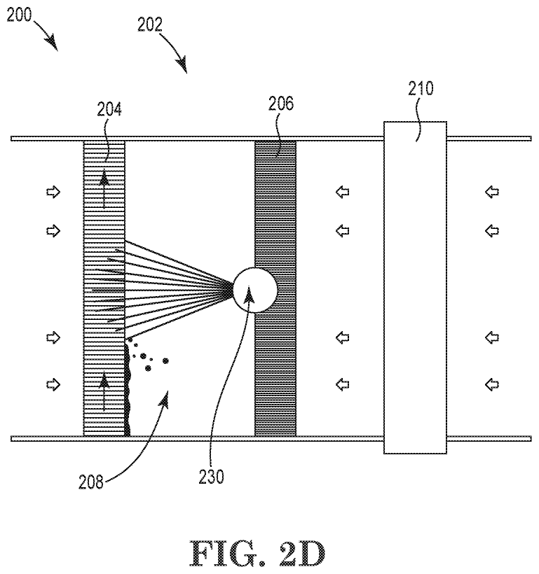

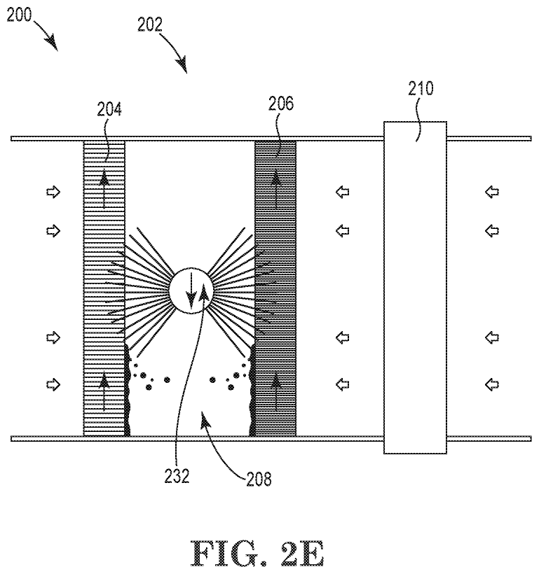

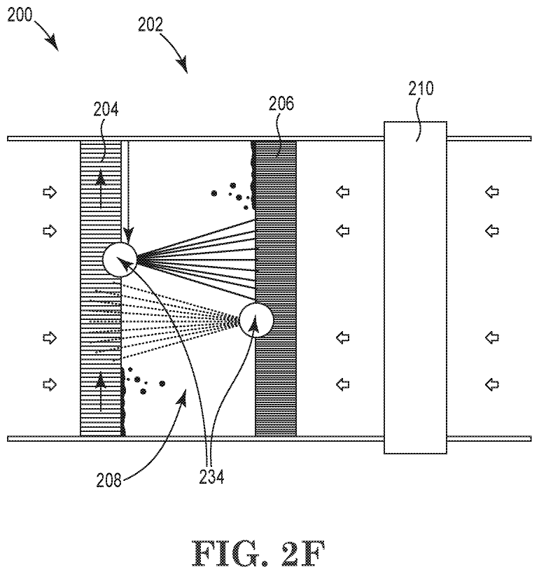

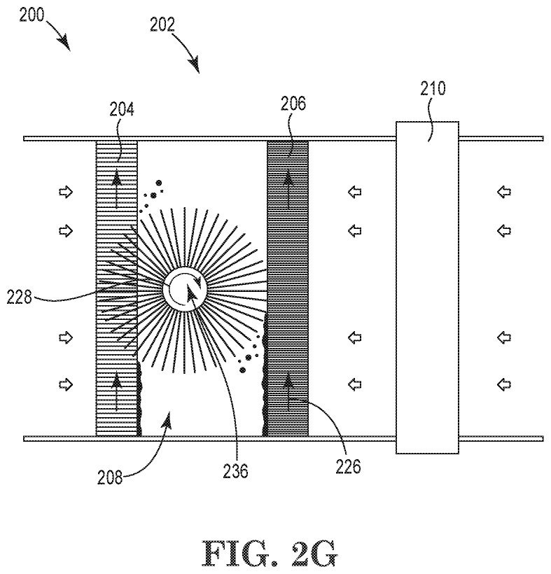

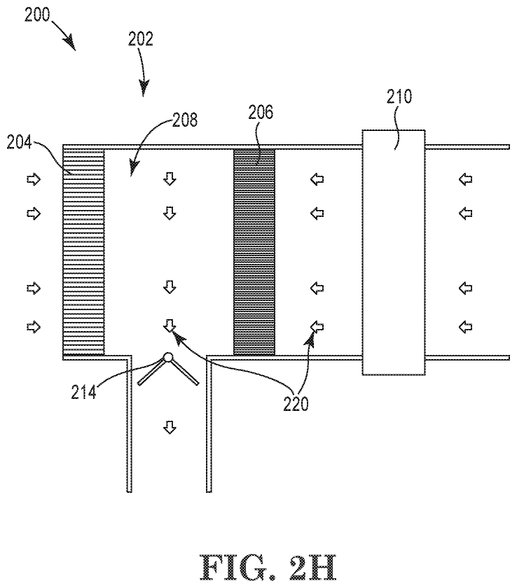

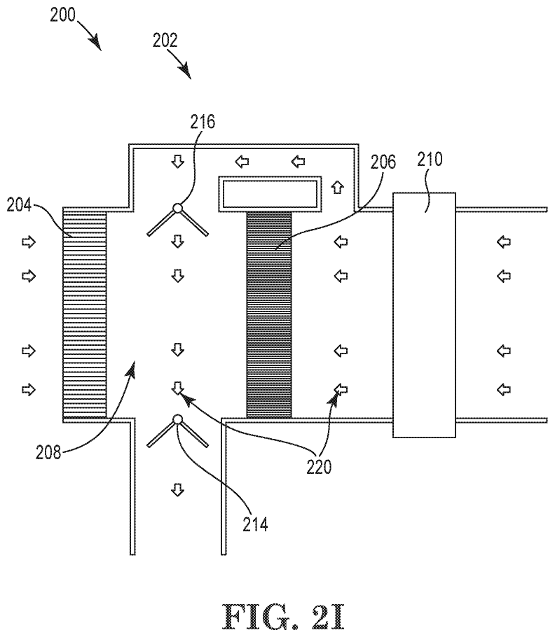

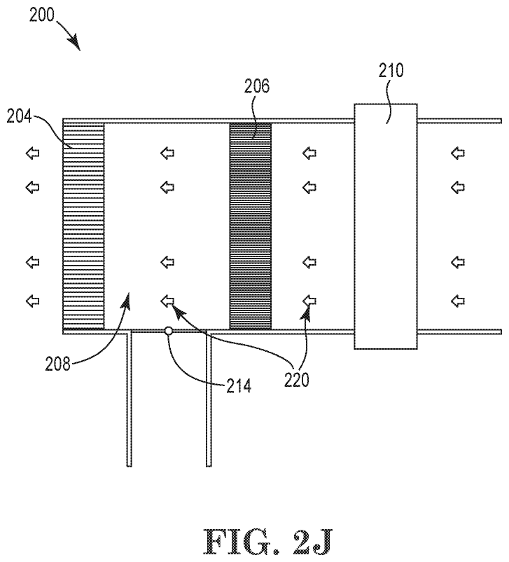

FIGS. 2A-2B illustrate an intake-event, or a first mode of operation, of a filter system in accordance with examples of the present invention. Specifically, FIG. 2A illustratively shows a side view of an intake event in which filtered water is produced. As shown, a filtration system 200 includes an intake-filter subsystem 202 with a plurality of filters (stages) 204 and 206, a valving subsystem 222 with a valve 214, and at least one pump(s) 210. Between filters 204 and 206 is an interstitial space 208 defining a fluid flow path between a downstream side of an upstream filter and an upstream side of a downstream filter across a filter face. In operation, intake-filter subsystem 202 may be supported by support structures (not shown), or load bearing members, that support the first and second filtration stages, and which may be fully or partially integrated with, or separate from, the filtration media so that such structures may be easily maintained or replaced.

As shown, in a first operating mode, one or more pump(s) 210 may draw a flow of source water along a first fluid pathway 212 to produce filtered water. In one example, first fluid pathway 212 is defined by a differential pressure developed by pump(s) 210 where a flow of source water is moved through one or more filtration stages with one or more interstitial spaces to produce a flow of filtered water. Specifically, as a flow of source water travels along first fluid pathway 212, filters 204 and 206 may allow for a successive filtration of source water along pathway 212 to produce filtered water. Filtered water may then be discharged or provided to additional downstream application, e.g., a desalination cartridge, outlet, etc.

In one example, an approach velocity of a flow of source water, when entering a first stage, e.g., filter 204, may be maintained below a critical impingement velocity, e.g., less than 0.5 feet per second, to adhere to EPA guidelines. Moreover, it is contemplated that an approach velocity of interstitial water exiting the first stage, e.g., filter 204, and entering a second stage, e.g., filter 206, may be greater than the velocity of feedwater entering the first stage, e.g., greater than 0.5 feet per second.

Filter 204 may have a courser porosity or larger opening size than filter 206, or stated differently, filter 206 may have a finer porosity or smaller opening size than filter 204. While two filters are illustratively shown, it is to be understood that system 200 may include any number of additional filtration stages, e.g., a third filter, a fourth filter, a reverse osmosis membrane, etc. downstream or upstream of stages 204 and 206. Each successive filtration stage may be assembled in series to filter out successively finer solids with minimal induced pressure drops while an interstitial space between adjacent filtration stages remains fluidically coupled to a common discharge port to evacuate entrained, dislodged, and suspended solids during a backwashing or backflushing event.

In operation, each filtration stage, from an outer upstream stage to an inner downstream stage, may contain successively smaller openings, pore diameters, slot widths, or channel sizes that filter out ever decreasing sizes of solids. A nominal opening size of each stage may vary and depend on local unconditioned feedwater properties and final conditioned feedwater quality targets, e.g., a first wedgewire screen with 500-um openings and a second woven textile with 50-um openings may deliver feedwater of specified quality for a downstream subsea reverse osmosis process. Further, a total open area and surface area of each filtration stage may be sized to minimize pressure drops, which may be generally maintained below the intake pressure drop limits of a downstream pump or process.

Each filtration stage may be in the form of 3D printed materials, flat sheets, concentric cylinders, or other flat, curved, or pleated surfaces with open porosity, e.g., wedge wire screens, woven textiles, felt fabrics, or other open porosity filters, structures, or granular media such as packed sand, gravel, anthracite, or other mechanical, chemical, electromagnetic, or biologically selective or non-selective, depth or surface filtration material. However, surface filtration mechanisms, such as screens or woven textiles, may be preferred. Each stage, and a corresponding support structure, may also include a single material or a combination of materials such as metal, plastic, composite, textile, fabric, glass, or other extruded, woven, pleated, machined, additive manufactured, porous, buoyant, artificial or natural materials.

As shown, interstitial space 208 is between filters 204 and 206 and serves as an entrapment area where solids smaller than the opening size of filter 204, but larger than the opening size of filter 206, are entrained, suspended or impinged onto an outer surface of filter 206. Interstitial space 208 may be opened or closed at a first or second end of a fluid pathway. Such opened ends may be in fluid communication with a second flow path to allow solids from the interstitial space to be flushed out of the space and either discharged into the open water body or supplied to a secondary downstream process.

In a first operating mode, valve 214 may also be in a closed position. However, as shown in FIG. 2B, valving subsystem 222 may also include a second valve 216 or any number of valves in accordance with the present invention. In one example, valving subsystem 222 confines flow through a filtration system when a pump, e.g., pump 210, operates in a first, intake, operating mode (forward direction). In a second, backwash or backflush, operating mode, valving subsystem 222 may allow for a reversed flow of interstitial water to be backwashed or flushed from the interstitial space when a pump, e.g., pump(s) 210, 308, 402, 502, 612, operates in the reverse direction or a second pump, e.g., pump(s) 404, 504, or third pump, e.g., pump 506, operates in the forward direction (illustratively shown in FIGS. 2C-2J, 3B, 4B, 5B, and 7). Additionally, in a second operating mode, valving subsystem 222 may prevent the ingress of source water into the interstitial water or filtered water. Further, this may also prevent the ingress of interstitial water with the filtered water. Valves of subsystem 222 may be passively, automatically, or manually controlled using several different valve mechanisms with or without moving parts, such as one-way flap valves, duckbill valves, Tesla valves, sleeve valves, piston valves, etc.

In some examples, as shown in FIGS. 2C-2G, filtration system 200 may also include a self-cleaning subsystem 218, 230, 232, 234, or 236 coupled to intake filter subsystem 202 to manage foul, extend a service life of system 200, and capture solids 238 within system 200. As will be discussed below, self-cleaning subsystems 218, 230, 232, 234, or 236 may include any combination of automated cleaning equipment to gently and thoroughly clean occluded screens and filters to safely dislodge impinged solids. In turn, such captured solids may be gently evacuated from system 200 unharmed during a backwash or backflush event. In one example this may result in no mortality of captured organisms up to a selected exclusion size. However, in other examples, such backwash or backflush of organisms into source water may result in a return of at least 10%, 20%, 30%, 40%, 50%, 60%, 70%, 80%, 90%, or 99% of alive organisms to the source water.

For example, as shown in FIGS. 2C-2G, filtration system 200 may include a self-cleaning subsystem 218, 230, 232, 234, or 236 coupled to intake-filter subsystem 202 for removing and displacing solids from either or both filters 204 and 206. While FIGS. 2C-2G illustratively show self-cleaning subsystems 218, 230, 232, 234, and 236 operating during a second operating mode(s), e.g., a cleaning, backflush, or backwash mode of operation, it is to be understood that self-cleaning subsystems 218, 230, 232, 234, and 236 may operate in a first operating mode (normal intake event) as well. Additionally, as shown in FIGS. 2C and 2F, self-cleaning subsystems 218 and 234 may be fixedly positioned on filter 204. Alternatively, as shown in FIGS. 2D and 2F, self-cleaning subsystems 230 and 234 may be positioned on filter 206, or, as shown in FIGS. 2E and 2G, within interstitial space 208. Self-cleaning subsystem 218 may include any number and type of brushes, blades, water jets, or air burst devices to safely capture solids within interstitial space 208 while also cleaning an interior or exterior surface of one or more filters, e.g., filters 204 and 206. In operation, such modules may clean and contact only one filtration stage, as shown in FIGS. 2C and 2D, or multiple stages simultaneously as shown in FIG. 2E 2F, and 2G. Additionally, as shown in FIG. 2F, any combination of modules may be used. For example, as shown in FIG. 2F, subsystem 234 may include a brush configured to sweep an outer surface of a second filtration stage and a water jet for spraying an interior surface of a first filtration stage. It is to be understood that any combination, number, and type of cleaning modules may be used in the present invention.

In some examples, as shown in FIGS. 2C-2G, self-cleaning subsystem 218 may also be passively or actively driven by a drive mechanism (not shown) to rotate along a cleaning axis, e.g., axis 228 shown in FIG. 2G. For example, a drive mechanism may be necessary to impart movement to self-cleaning subsystem 218 to adequately clean each filtration stage. A drive mechanism may include any number of drive chains or belts, motor drive gears, screen gear boxes, motors, etc. to elicit rotational or translational movement, e.g., movement 226 in FIG. 2G, of filters 204 and 206, and, passively or actively, self-cleaning subsystem 218. This may ensure that all, or substantially all, captured solids are safely removed from filters 204 and 206 and suspended within interstitial space 208. In one example, actively driving movement of one or more filters may passively drive subsystems 218, 232, and 236. Specifically, a drive mechanism may include a drive train coupled to one or more filters to actively impart movement to the filters. In turn, as the filters rotate, cleaning modules of subsystem 218, 232, and 236 coupled to the filter(s) may passively rotate to ensure proper and adequate cleaning.

After, before, or during an intake or cleaning event, a backwash or backflush event may be carried out in a second operating mode to return captured solids safely to source water. In accordance with the present disclosure, it is to be understood that system 200 may include a unique selection of optimized flow pathways, pressures, timing, and compatible materials to minimize contact, turbulence, pressure, shear, and osmotic stresses known to induce the mortality of entrained organisms during backwash and backflush operating modes. Further, in a forward operation, while a pump may draw in water through an intake and out of an outfall riser, in a second operating mode, a volume of the riser may dictate how much filtered water is available for a backwashing or backflushing event. As such, it is contemplated that any number of different risers may be used to supply the necessary amounts of filtered water.

FIGS. 2H-2J illustratively show a side-view of a backflush or backwash event (second mode of operation) in accordance with examples of the present invention. As shown in FIGS. 2H-2J, during a backflush or backwash event, one or more pump(s) 210 may operate in reverse to displace filtered water along a second fluid pathway 220 to return captured solids to source water. In one example, as pump(s) 210 operate in reverse, one or more valve(s) 214 and 216, as shown in FIGS. 2H and 2I, may be opened to allow for passage of the filtered water along second fluid pathway 220. Second fluid pathway 220, as shown in FIGS. 2H and 2I, may include interstitial space 208 and a channel leading to a discharge outlet (not shown) to return the captured solids to source water, a collection container, or other downstream equipment. By returning captured solids to their natural environment, potential environmental damage may be mitigated and avoided. Second fluid pathway 220 may be defined by a differential pressure developed by pump 210 in reverse, or an optional second pump, where filtered water is moved in a generally opposing direction of the first flow path in a first operating mode. In one example, this creates an inverted differential pressure to backwash or flush filtered, source, or interstitial water from upstream filtration stages (or from the original source) to a discharge outlet.

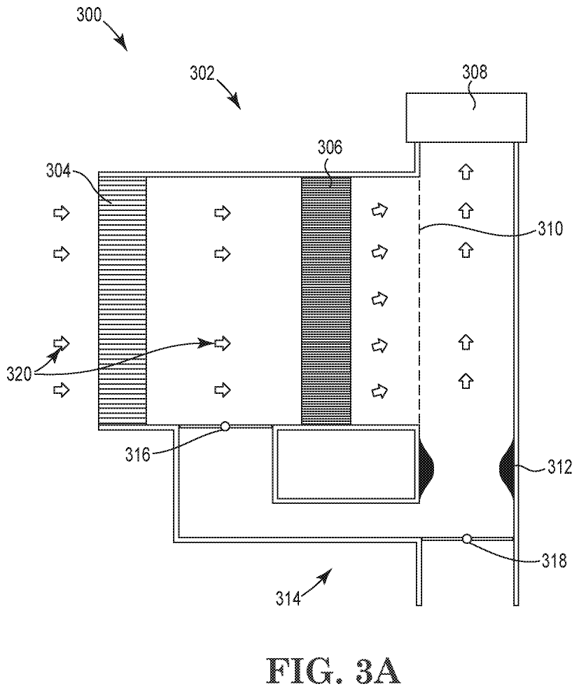

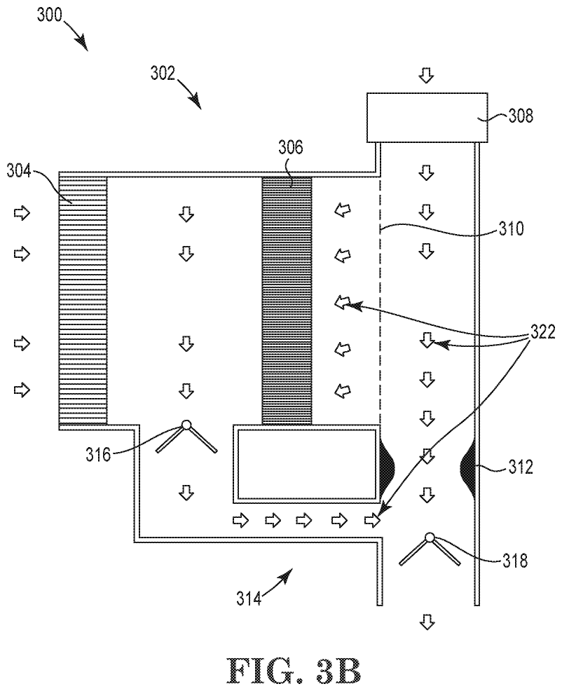

FIGS. 3A-3B illustratively show a filtration system in accordance with examples of the present invention. As shown in FIG. 3A, a filtration system 300 includes an intake filter subsystem 302 with a plurality of filters 304 and 306, a pump 308, a flow modifier 310, a flow restrictor 312, and a valving subsystem 314 with valves 316 and 318. In a first operating mode (intake event), as shown in FIG. 3A, a flow of source water may travel along a first fluid pathway 320 to forward operating pump(s) 308. As source water travels along fluid pathway 320, filters 304 and 306 may allow for a successive filtration of solids from the source fluid to produce filtered water. Additionally, flow modifier 310 may evenly distribute first flow path 320 across porous surfaces of filters 304, 306 and convey a resulting filtered intake flow of water to a secondary downstream process, such as a subsea reverse osmosis process.

In a second operating mode, as shown in FIG. 3B, valves 316 and 318 may be opened and pump 308 operated in reverse to drive filtered or source water along a second fluid pathway 322 through flow restrictor 312 to produce a pressure drop. Flow restrictor 312 may partially constrict and then rapidly expand fluid pathway 322 to accelerate the velocity of fluid in the vicinity of the interstitial flow pathway, such that the increased fluid velocity induces a pressure drop and corresponding flow of the interstitial flow along path 322, similar to the mechanisms of Venturi-type or pitot-type flow restrictors. Additionally, flow modifier 310 may modulate path 322 towards the discharge outlet in one of two directions: by way of filter 306 or by way of flow restrictor 312 or, in some examples, a second pump. Filtered and interstitial water may pass along second fluid pathway 322 to source water.

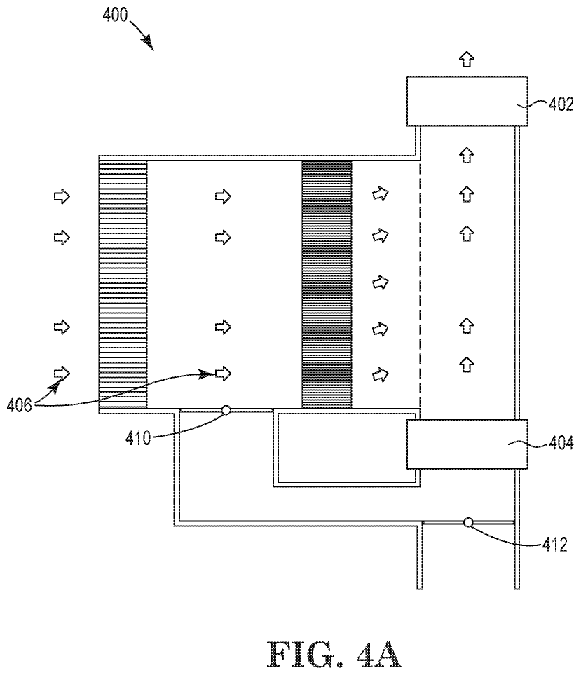

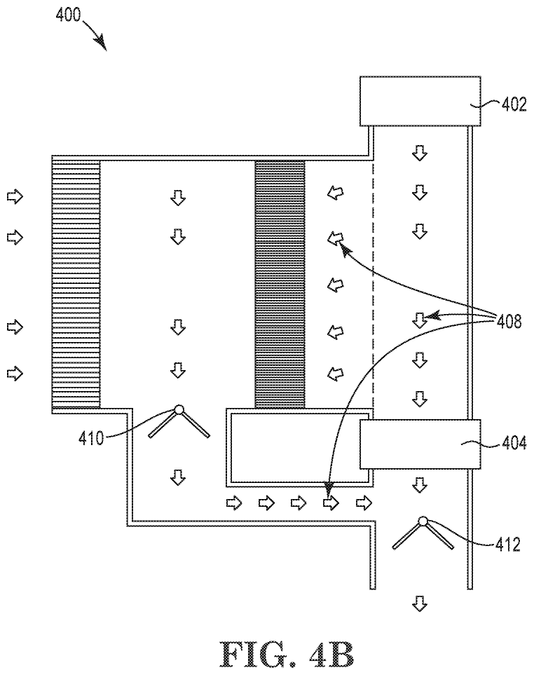

FIGS. 4A-4B illustratively show a filtration system in accordance with examples of the present invention. As illustratively shown, a filtration system 400 includes similar components to filtration system 300, but with a plurality of pumps 402 and 404. In a first operating mode, as shown in FIG. 4A, pump 402 may be operated in a forward direction and pump 404 turned off. In this example, a flow of source fluid may travel along a first fluid pathway 406 through each filtration stage to produce a flow of filtered water. Alternatively, in a second operating mode, as shown in FIG. 4B, pump 402 may operate in reverse, or off, and pump 404 activated to produce a pressure drop and drive filtered or source water and interstitial water along a second fluid pathway 408 to source water. Further, in this example, in a first operating mode, valve(s) 410 and 412 may be closed, while in a second operating mode, both valves 410 and 412 may be opened.

While pump 402 may be driven forward or in reverse, it is also contemplated that, in other examples, pump 402 may be driven forward or turned off during a first and second operating mode, respectfully. In this example, only pump 404 may be used in the second operating mode to produce a pressure drop and corresponding flow of filtered and interstitial water to source water.

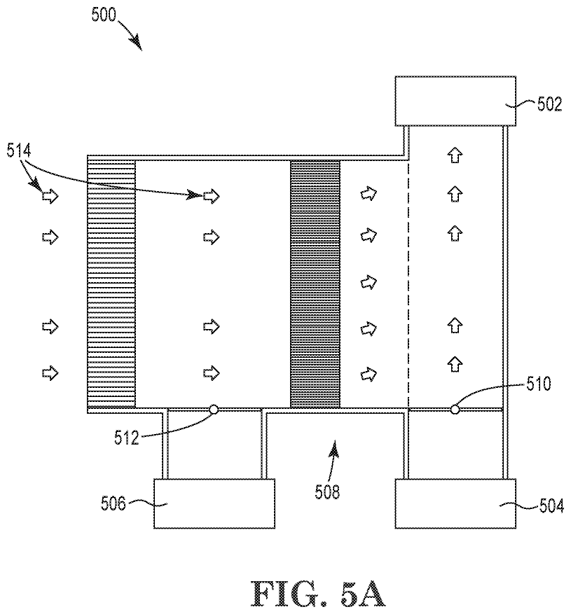

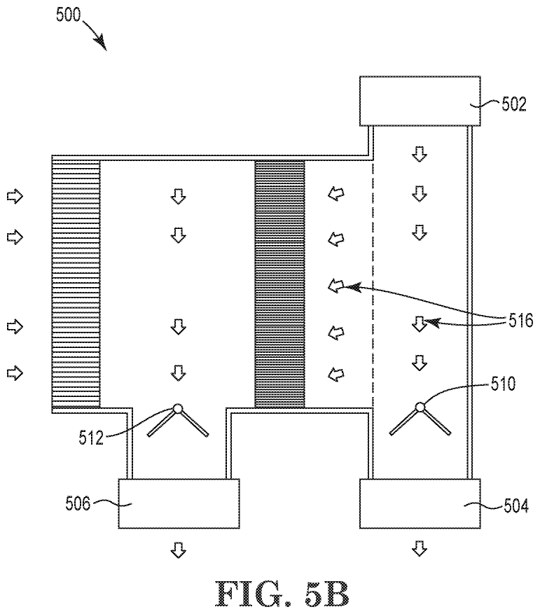

FIGS. 5A-5B illustratively show a filtration system in accordance with examples of the present invention. In this example a filtration system 500 includes a plurality of pumps 502, 504, and 506 and a valving subsystem 508. While valving subsystem 508 illustratively includes two valves, 510 and 512, any number of valves may be used. In a first operating mode, as shown in FIG. 5A, pump 502 may operate in a forward direction to draw in a flow of source water along a first fluid pathway 514 and produce filtered water. In turn, filtered water may be provided to any number of downstream processes, supplied to source water, etc. In this example, valves 510 and 512 may remain closed while pumps 504 and 506 remain off. In a second operating mode, as shown in FIG. 5B, pump 502 may be turned off or operated in reverse, valve(s) 510 and 512 opened, and pumps 504 and 506 turned on to draw a flow of filtered and interstitial water along a second fluid pathway 516 to source water. In this example, pump 504 may redirect a flow of filtered water to an outlet while pump 506 produces a pressure drop and flow of interstitial water to the same or different outlet.

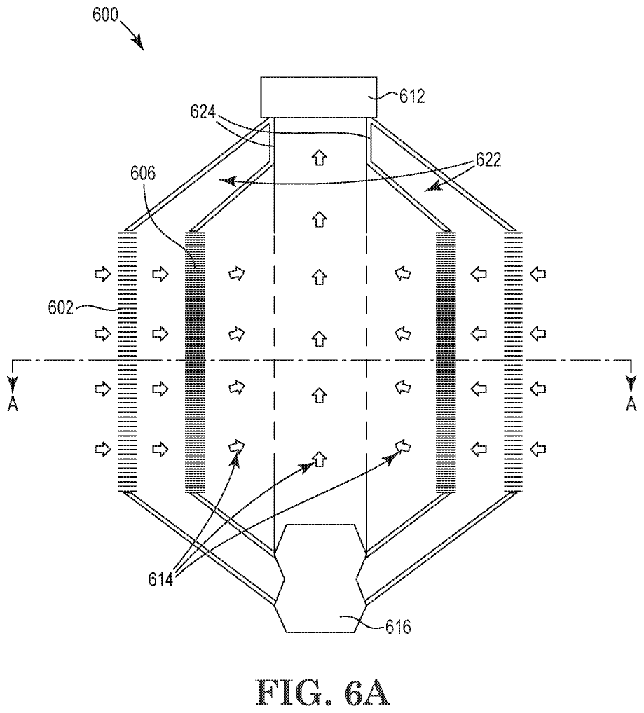

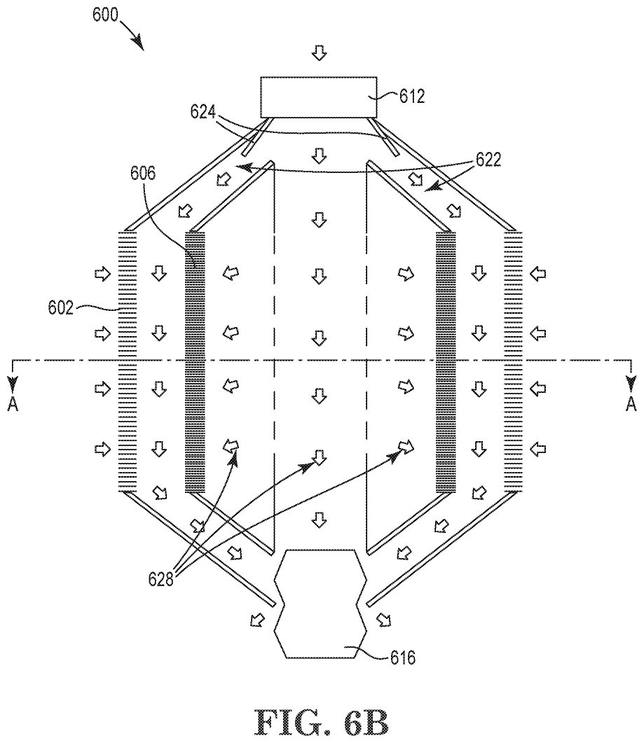

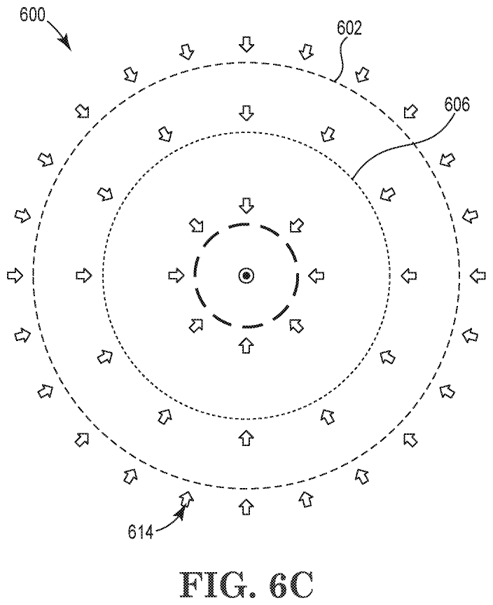

FIGS. 6A-6C illustratively show a filtration system with a plurality of concentric cylindrical filters in accordance with examples of the present invention. As shown in FIGS. 6A-6B, a filtration system 600 includes a pump 612, one-way valves 616 and 624, a flow modifier 626, and a plurality of concentric cylindrical filters 602, 606 for producing filtered water. While system 600 illustratively includes two concentric cylindrical filters 602 and 606, it is to be understood that any number of concentric filters may be used. In a first operating mode, as shown in FIG. 6A, pump 612 may draw a flow of source water into each cylinder 602 and 606 along a first fluid pathway 614 to produce filtered water. In turn, filtered water may be provided to flow modifier 626 and any number of downstream processes, e.g., desalination, filtration, etc. In a second operating mode, as shown in FIG. 6B, pump 612 may operate in reverse to drive filtered water through opened valve(s) 624, passageway(s) 622, interstitial space(s) between cylindrical filter(s) 602 and 606, and valve 616 along a second fluid pathway 624 to return captured solids to source water. While valves 616 and 624 are closed in the first operating mode, in the second mode, valves 616 and 624 may be opened. In one example, valve 616 may include a one-way valve mechanism, near the terminal end of a second flow pathway, to flush suspended particulate matter and organisms from an interstitial space and restrict an ingress of unfiltered feedwater into an interstitial space when closed. Further, in this example, a valve mechanism may allow for a backflow of interstitial feedwater driven by a downstream suction pressure when opened during a cleaning event. This may allow for an additional level of redundancy to restrict the ingress of source water through the discharge outlet during a first mode of operation.

FIG. 6C shows a cross-sectional view at A-A in FIGS. 6A-6B. As shown, concentric cylinder 602 may allow for source water entry at any point surrounding or encapsulating cylinder 602 along first fluid pathway 614. In this example, a flow of source water may be continuously received at any point surrounding system 600 and used to produce filtered water.

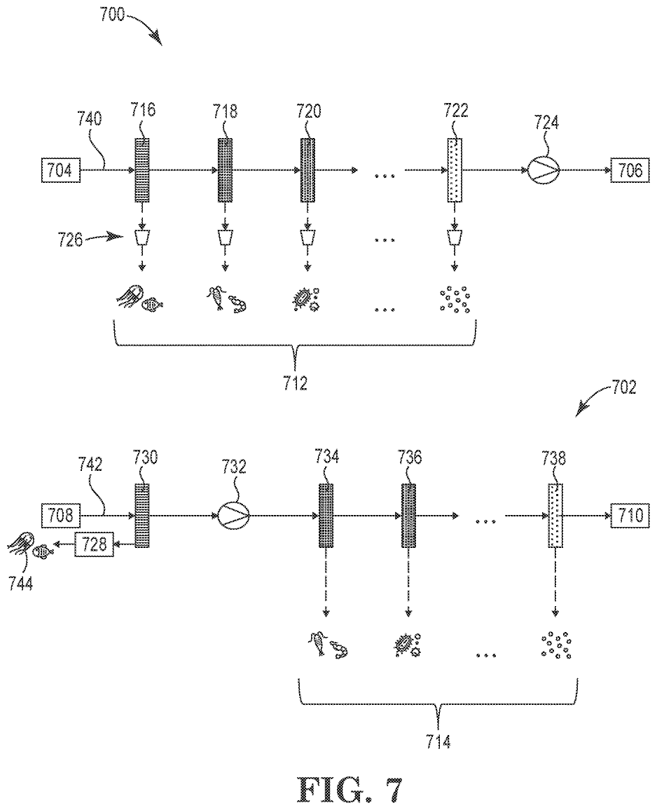

FIG. 7 illustratively shows process diagrams of the disclosed multistage filter system versus a filtered intake system having only one filter at a pump inlet, and comparing outcomes for impinged and entrained solids that may enter downstream pretreatment processes. As shown, a multistage filtration system 700 of the present disclosure may include a plurality of filtration stages 716, 718, 720, 722 located upstream of a reversible pump 724 for receiving a flow of source water 704 along a fluid pathway 740 and filtering out solids 712 to produce filtered water 706. In a first operating mode, solids 712 may be impinged or trapped as each stage 716, 718, 720, and 722 includes finer porosities or smaller opening sizes than a preceding stage. For example, a first stage 716 may prohibit passage of solids 712 greater than 1 mm, second stage 718 greater than 100 μm, third stage 720 greater than 10 μm, fourth stage 722 greater than 1 μm, etc. In accordance with the present disclosure, it is to be understood that any number of different stages or filters with decreasing opening sizes or porosities may be used.

As solids 712 become impinged or captured between filters 716, 718, 720, and 722, a self-cleaning subsystem 726, e.g., brushes, water jets, air jets, etc., coupled to each filter 716, 718, 720, and 722 may operate in a cleaning mode to dislodge impinged solids 712 into an interstitial space between each filter 716, 718, 720, and 722. In turn, pump 724 may operate in reverse during a backflush or backwash mode of operation to direct a flow of filtered water 706 through one or more internal channels fluidically coupled to each interstitial space and a life-friendly return outlet to safely return the captured solids 712 to source water 704. As a result, significant proportions (for example, at least 50%, at least 60%, at least 70%, at least 80% or at least 90%) of captured solids 712 may be safely returned to source water 704.

A system such as submerged intake system 702 may also include a plurality of filtration stages 730, 734, 736, and 738, and a reversible intake pump 732 fluidically coupled between stages 730 and 734 for producing a flow of filtered water 710 from source water 708 along fluid pathway 742. System 702 captures large organisms 744 at filter stage 730. When cleaning of stage 730 is desired, reversal of pump 732 provides a singular backflush cleaning mechanism 728 that returns organisms 744 to source water 708. Smaller organisms 714 that pass through filtration stage 730 may face 100% mortality upon passing through pump 732 or upon becoming entrapped within downstream filtration stages 734, 736, and 738, and cleaning mechanism 728 may also result in significant organism 744 mortality. As compared to intake system 702, the disclosed multi-stage filtration system 700 allows for a more effective, safe, and efficient return of captured and impinged solids into the water source as filtered water is produced.

In accordance with the present invention, it is to be understood that any number of filters, cleaning devices, valves, hydraulic stabs, or pumps may be used as part of a filtration system. For example, in some cases, it may be desirable to include three or more filters with a plurality of, e.g., two or more, interstitial spaces to allow for further filtration of source water. Additionally, a filtration system may also include any number of electrical components, pump controllers, sensors, motors, software, or hardware for carrying out a filtration operation that safely displaces captured solids in source water. For example, one or more sensors may generate sensor signals indicative of a triggering event. A triggering event may include a presence of organisms, a visual indication, a period of time, a flow rate, a pressure drop, a rotational speed of one or more filters or cleaning devices, etc. Based on the sensor signals, a controller may, in turn, switch operating modes of one or more pumps or valves. Alternatively, in some examples, a pump controller may passively switch between operating modes. In one example, a pump may automatically switch between operating modes. Moreover, each operating mode may occur over discrete cycle lengths. In one example, a first operating mode may have a longer cycle length than a second operating mode. However, alternatively, a cycle length between the first and second cycles may be substantially equal in other examples.

A filter system may also include one or more downstream desalination systems for reverse osmosis and the production of fresh water. For example, a first fluid pathway may include a passage through one or more filters of an intake filter subsystem, desalination systems, and a freshwater outlet. Each respective filtration stage may be fluidically coupled. Alternatively, a second pathway may then include a passage through one or more desalination systems, intake filter subsystems, and a source water outlet. In operation, a downstream desalination system may receive a filtered intake flow of water from an intake subsystem and produce fresh water. In this example, the filtration system may include any number of filtration stages to sufficiently filter out a flow of source water to nominal particles sizes of about 5-10 microns to minimize clogging and fouling of the reverse osmosis membrane material and a crossflow space of standard spiral-wound elements.

It is also to be understood that any or all the pumps of a filtration system may be inline axial or mixed flow pumps or similar high-volume/low-pressure pumps that can move large volumes of fluid, while overcoming the relatively low pressure drops induced by upstream or downstream equipment, such as multistage filters or submerged reverse osmosis membrane elements. Axial/mixed flow pumps may be advantageous because, when run at low speed, they produce minimal pressure changes, shearing, turbulence, and other localized effects that could kill or damage small, entrained organisms by disrupting the osmotic pressure balance of their cellular structures. However, other pump styles, such as centrifugal or displacement pumps, that produce greater pressure differentials may be acceptable when aquatic life mortality is not a concern, e.g., filtering within dead zones with no significant biological activity. Alternatively, pumps may also include life-friendly pumps that operate under such parameters and conditions that do not pose a mortality risk to captured or entrapped organisms.

Having thus described preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated. Claims:

1. A filtration system for producing filtered water and returning solids to a source water environment, comprising:
at least one pump;
an intake filter subsystem fluidically coupled to the source water and the at least one pump, wherein the intake filter subsystem comprises a plurality of filters separated by interstitial space(s) defining a fluid flow path between a downstream face of an upstream filter and an upstream face of a downstream filter, and the intake filter subsystem is configured to receive a flow of source water, capture organisms from the flow of source water, and produce a filtered intake flow of water; and
wherein the system is configured to operate in a plurality of operating modes, wherein, in a first operating mode, the filtered intake flow is received from the intake filter subsystem along a first fluid pathway to produce filtered water at a first system outlet, and, in a second operating mode, a flow of filtered water is periodically provided to a second fluid pathway and a second system outlet to wash captured organisms alive back into the source water, and wherein the second fluid pathway comprises the interstitial space and flow across the downstream and upstream filter faces to the second system outlet.

2. The filtration system of claim 1, wherein the intake filter subsystem is further configured to capture non-living solids from the received flow of source water and, while in the second operating mode, the flow of filtered water washes the captured non-living solids and organisms back into the source water.

3. The filtration system of claim 1, wherein the first and second operating modes are configured to return alive at least 10% of captured organisms to the source water.

4. The filtration system of claim 1, further comprising:
a self-cleaning subsystem coupled to the intake filter subsystem configured to remove non-living solids and organisms from at least one of the plurality of filters and disperse the non-living solids and organisms within the interstitial space.

5. The filtration system of claim 4, wherein the self-cleaning subsystem comprises at least one of brushes, blades, pistons, water jets, or air bursts.

6. The filtration system of claim 1, wherein the at least one pump comprises a reversible pump configured to operate in the first mode to receive the flow of source water and in the second operating mode to return the organisms to source water.

7. The filtration system of claim 1, wherein, in the second operating mode, the at least one pump creates backpressure to dislodge the organisms to source water or the interstitial space(s).

8. The filtration system of claim 1, wherein the intake filter subsystem comprises:
at least three successive filters and at least two interstitial spaces defining fluid flow pathways across downstream and upstream filter faces to the second system outlet.

9. The filtration system of claim 1, wherein the first operating mode comprises a continuous flow of source water through the filtration system to produce a continuous flow of filtered water.

10. The filtration system of claim 1, wherein the second operating mode is configured to occur intermittently based on a detected triggering event comprising at least one of a presence of organisms, a visual indication, a period of time, a flow rate, or a pressure drop.

11. The filtration system of claim 1, wherein the first and the second fluid pathways prohibit captured non-living solids and organisms from entering the at least one pump.

12. The filtration system of claim 1, wherein the flow of source water comprises salinated seawater and the filtration system further comprises:
at least one desalination system fluidically coupled to the intake filter subsystem and the at least one pump, the at least one desalination system configured to receive the flow of salinated seawater and produce a flow of desalinated water.

13. The filtration system of claim 1, wherein the at least one pump is positioned downstream of all filtration stages to prevent organisms having greater than a selected size from entering the at least one pump.

14. The filtration system of claim 1, further comprising:
at least one sensor coupled to either or both the first fluid pathway and the second fluid pathway configured to generate a sensor signal indicative of an operating characteristic of the filtration system; and
at least one controller coupled to the at least one sensor configured to receive the sensor signal and modify an operating parameter of the filtration system based on the received sensor signal.

15. A multi-stage filtration system for producing filtered water and returning captured solids to source water, comprising:
at least one pump;
an intake filter subsystem, fluidically coupled to the at least one pump, configured to receive a flow of source water and filter out organisms from the flow of source water;
a self-cleaning subsystem coupled to the intake filter subsystem and configured to periodically remove and displace organisms from the intake filter subsystem into an interstitial space between successive filters of the intake filter subsystem; and
wherein the multi-stage filtration system is configured to operate in a plurality of operating modes wherein, in a first operating mode, the intake filter subsystem receives the flow of source water to produce a flow of filtered water along a first fluid pathway, and, in a second operating mode, the flow of filtered water is provided to the interstitial space and flows along a second fluid pathway across downstream and upstream filter faces of the successive filters and through an outlet of the multi-stage filtration system to return the organisms to source water.

16. The multi-stage filtration system of claim 15, wherein the intake filter subsystem is further configured to filter out non-living solids from the received flow of source water and, when in the second operating mode, the flow of filtered water returns the non-living solids and organisms back into the source water.

17. The filtration system of claim 15, further comprising:
a drive mechanism operably coupled to the intake filter subsystem and the self-cleaning subsystem to drive movement of the intake filter subsystem and the self-cleaning subsystem with respect to one another.

18. The filtration system of any claim 15, further comprising:
a valving subsystem fluidically coupled to the first and second fluid pathways and configured to control the flow of source water and the flow of filtered water through the first and second fluid pathways.

19. A method of producing filtered water and returning captured solids to source water, the method comprising:
operating a multi-stage filtration system in a first operating mode to receive a flow of source water along a first fluid pathway and produce a flow of filtered water at a first system outlet, the first fluid pathway comprising a plurality of successively finer filters configured to remove organisms from the flow of source water; and
operating the multi-stage filtration system in a second operating mode to direct the flow of filtered water along a second fluid pathway to a second system outlet to return the organisms to source water, the second fluid pathway comprising an interstitial space between successive filters and flowing across downstream and upstream filter faces of the interstitial space to the second system outlet.

20. The method of claim 19, wherein the multi-stage filtration system is configured to operate in the second operating mode after a triggering event, the triggering event comprising a presence of organisms, a visual indication, a period of time, a flow rate, or a pressure drop, and wherein the first and second operating modes are configured to return alive at least 50% of captured organisms to the source water.
